(19) United States
(12) Patent Application Publication
(10) Pub. No.: US 2021/0123355 A1
(43) Pub. Date: Apr. 29, 2021

(54) SYSTEM FOR AN IMPROVED STATOR ASSEMBLY

(71) Applicant: UNITED TECHNOLOGIES CORPORATION, Farmington, CT (US)

(72) Inventors: Sarah J. Zecha, Concord, NH (US); Brian Duguay, South Berwick, ME (US); Nicholas Hunnewell, North Berwick, ME (US)

(73) Assignee: UNITED TECHNOLOGIES CORPORATION, Farmington, CT (US)

(21) Appl. No.: 16/667,578

(22) Filed: Oct. 29, 2019

(51) Int. Cl. F01D 9/04; F01D 5/14

(52) U.S. Cl. CPC F01D 9/042; F01D 5/143; F05D 2240/122; F05D 2220/323; F05D 2300/437; F05D 2220/36; F05D 2250/711; F05D 2230/60

(57) ABSTRACT

A stator assembly, in accordance with various embodiments, is disclosed herein. The stator assembly comprises either a first bumper or a first tab. The first bumper or the first tab extends circumferentially outward from a mating portion of the vane towards a slot in a ring. The ring may be an outer diameter (OD) ring or an inner diameter (ID) ring. The mating portion of the vane may be coupled to the ring by a potting component. The potting component may prevent direct contact between the vane and the ring.

### FIELD

The present disclosure relates to gas turbine engines, and more specifically, to a system for an improved stator assembly.

### BACKGROUND

Gas turbine engines typically include a compressor section to pressurize inflowing air, a combustor section to burn a fuel in the presence of the pressurized air, and a turbine section to extract energy from the resulting combustion gases. The compressor section typically may comprise alternating rows of rotors and stators, ending with an exit guide vane. The exit guide vane may be angled to remove swirl from the inflowing air, before directing air into a diffuser assembly.

### SUMMARY

A stator assembly is disclosed herein. The stator vane assembly may comprise: a vane comprising a suction side, a mating portion, and a first bumper, the first bumper disposed on the suction side and extending circumferentially away from the suction side; a ring having a slot configured to receive the vane; a potting component disposed between the mating portion of the vane and the slot of the ring, the potting component configured to join the vane and the ring.

In various embodiments, the first bumper extends substantially orthogonal to the suction side. The first bumper may be disposed proximate a leading edge of the vane. The stator assembly may further comprise a second bumper disposed on the suction side of the vane. The second bumper may be disposed proximate a trailing edge of the vane. The vane may be a monolithic component.

A stator assembly is disclosed herein. The stator assembly may comprise: a vane comprising a suction side, a mating portion, and a first tab, the first tab disposed on the suction side and extending circumferentially away from the suction side; a ring having a slot configured to receive the vane; a potting component disposed between the mating portion of the vane and the slot of the ring, the potting component configured to join the vane and the ring.

In various embodiments, the first tab may extend substantially orthogonal to the suction side. The stator assembly may further comprise a first circumferential recess disposed in the slot proximate the first tab, wherein the first circumferential recess is configured to receive the first tab. The first tab may be disposed proximate a leading edge of the vane. The stator assembly may further comprise a second tab disposed on the suction side of the vane. The second tab may be disposed proximate a trailing edge of the vane. The stator assembly may further comprise a second circumferential recess disposed in the slot proximate the second tab, wherein the second circumferential recess is configured to receive the second tab. The vane may be a monolithic component.

A gas-turbine engine is disclosed herein. The gas turbine engine may comprise: a compressor section; a stator assembly disposed aft of the compressor section, the stator assembly comprising: a vane comprising a suction side, a mating portion, and a first tab or a first bumper, the first tab or the first bumper disposed on the suction side and extending circumferentially away from the suction side; a ring having a slot configured to receive the vane; and

a potting component disposed between the mating portion of the vane and the slot of the ring, the potting component configured to join the vane and the ring.

In various embodiments, the ring may further comprise a first circumferential recess disposed in the slot proximate the first tab, wherein the first tab or the first bumper is the first tab. The first tab may be disposed proximate a leading edge of the vane, wherein the vane further comprises a second tab disposed on the suction side proximate a trailing edge of the vane, the second tab extending circumferentially away from the suction side. The ring may further comprise a second circumferential recess disposed in the slot proximate the second tab, wherein the second circumferential recess is configured to receive the second tab. The first bumper or the first tab may be the first bumper. The vane may be a monolithic component.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a gas turbine engine, in accordance with various embodiments;

FIG. 2 illustrates a low pressure compressor section of a gas turbine engine, in accordance with various embodiments;

FIG. 3 illustrates a perspective cross-section view of an exit guide vane, in accordance with various embodiments;

FIG. 4 illustrates a cross-sectional view of a stator assembly, in accordance with various embodiments;

FIG. 5 illustrates a perspective view of a stator assembly, in accordance with various embodiments; and

FIG. 6 illustrates a cross-sectional view of a stator assembly, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts but not necessarily to denote the same or different materials.

As used herein, “aft” refers to the direction associated with the tail (e.g., the back end) of an aircraft, or generally, to the direction of exhaust of the gas turbine engine. As used herein, “forward” refers to the direction associated with the nose (e.g., the front end) of an aircraft, or generally, to the direction of flight or motion.

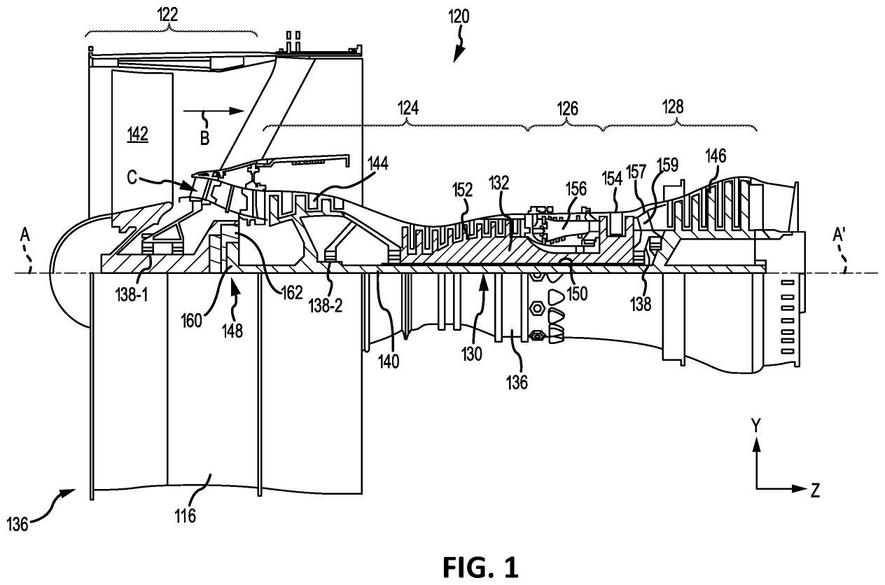

In various embodiments, and with reference to FIG. 1, a gas turbine engine 120 is disclosed. Gas turbine engine 120 may comprise a two-spool turbofan that generally incorporates a fan section 122, a compressor section 124, a combustor section 126, and a turbine section 128. Gas turbine engine 120 may also comprise, for example, an augmenter section, and/or any other suitable system, section, or feature. In operation, fan section 122 may drive air along a bypass flow-path B, while compressor section 124 may further drive air along a core flow-path C for compression and communication into combustor section 126, before expansion through turbine section 128. FIG. 1 provides a general understanding of the sections in a gas turbine engine, and is not intended to limit the disclosure. The present disclosure may extend to all types of applications and to all types of turbine engines, including, for example, such as turbojets, turboshafts, and three spool (plus fan) turbofans wherein an intermediate spool includes an intermediate pressure compressor (“LPC”) between a Low Pressure Compressor (“LPC”) and a High Pressure Compressor (“HPC”), and an Intermediate Pressure Turbine (“IPT”) between the High Pressure Turbine (“HPT”) and the Low Pressure Turbine (“LPT”).

In various embodiments, gas turbine engine 120 may comprise a low speed spool 130 and a high speed spool 132 mounted for rotation about an engine central longitudinal axis A-A′ relative to an engine static structure 136 via one or more bearing systems 138 (shown as, for example, bearing system 138-1 and bearing system 138-2 in FIG. 1). It should be understood that various bearing systems 138 at various locations may alternatively or additionally be provided, including, for example, bearing system 138, bearing system 138-1, and/or bearing system 138-2.

In various embodiments, low speed spool 130 may comprise an inner shaft 140 that interconnects a fan 142, a low pressure (or first) compressor section (“LPC”) 144, and a low pressure (or first) turbine section 146. Inner shaft 140 may be connected to fan 142 through a geared architecture 148 that can drive fan 142 at a lower speed than low speed spool 130. Geared architecture 148 may comprise a gear assembly 160 enclosed within a gear housing 162. Gear assembly 160 may couple inner shaft 140 to a rotating fan structure. High speed spool 132 may comprise an outer shaft 150 that interconnects a high pressure compressor (“HPC”) 152 (e.g., a second compressor section) and high pressure (or second) turbine section 154. A combustor 156 may be located between HPC 152 and high pressure turbine 154. A mid-turbine frame 157 of engine static structure 136 may be located generally between high pressure turbine 154 and low pressure turbine 146. Mid-turbine frame 157 may support one or more bearing systems 138 in turbine section 128. Inner shaft 140 and outer shaft 150 may be concentric and may rotate via bearing systems 138 about engine central longitudinal axis A-A′. As used herein, a “high pressure” compressor and/or turbine may experience a higher pressure than a corresponding “low pressure” compressor and/or turbine.

In various embodiments, the air along core airflow C may be compressed by LPC 144 and HPC 152, mixed and burned with fuel in combustor 156, and expanded over high pressure turbine 154 and low pressure turbine 146. Mid-turbine frame 157 may comprise airfoils 159 located in core airflow path C. Low pressure turbine 146 and high pressure turbine 154 may rotationally drive low speed spool 130 and high speed spool 132, respectively, in response to the expansion.

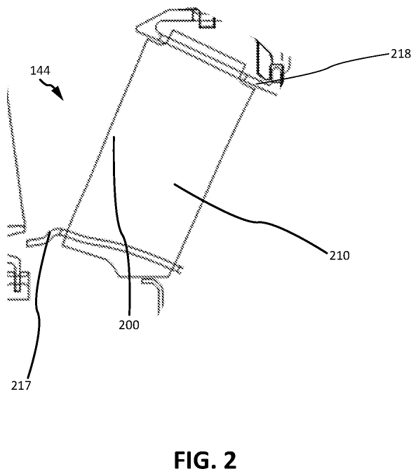

In various embodiments, and with reference to FIG. 2, LPC 144 of FIG. 1 is depicted in greater detail. Inflowing air may proceed through LPC 144 and into a stator assembly 200. The inflowing air may travel through a stator assembly 200, configured to define an air flow path from the rotating LPC 144 module to HPC 152 (from FIG. 1). In various embodiments, stator assembly 200 may be mounted adjacent to HPC 152 (from FIG. 1), in gas turbine engine 120. Stator assembly 200 may comprise a full ring stator assembly, wherein a plurality of stator assemblies 200 may be located circumferentially around the defined airflow path.

In various embodiments, stator assembly 200 may increase pressure in LPC 144, and straighten and direct air flow. Stator assembly 200 may comprise an inner diameter (ID) ring 217 radially spaced apart from an outer diameter (OD) ring 218. In various embodiments, OD ring 218 may form a portion of an outer core engine structure, and ID ring 217 may form a portion of an inner core engine structure to at least partially define an annular core gas flow. In various embodiments, stator assembly 200 may be configured to couple to the inside of gas turbine engine 120 using any suitable method known in the art, such as, for example, via OD ring 218 and ID ring 217. For example, OD ring 218 and ID ring 217 may each comprise a tab located on a radially outward surface (from engine central longitudinal axis A-A′), configured to couple with a slot in the inside of gas turbine engine 120. In various embodiments, an exit guide vane 210 may be coupled at a first end to OD ring 218 and coupled at a second end to ID ring 217. Exit guide vane 210 may be configured to reduce airflow swirl and direct airflow into HPC 152 (from FIG. 1).

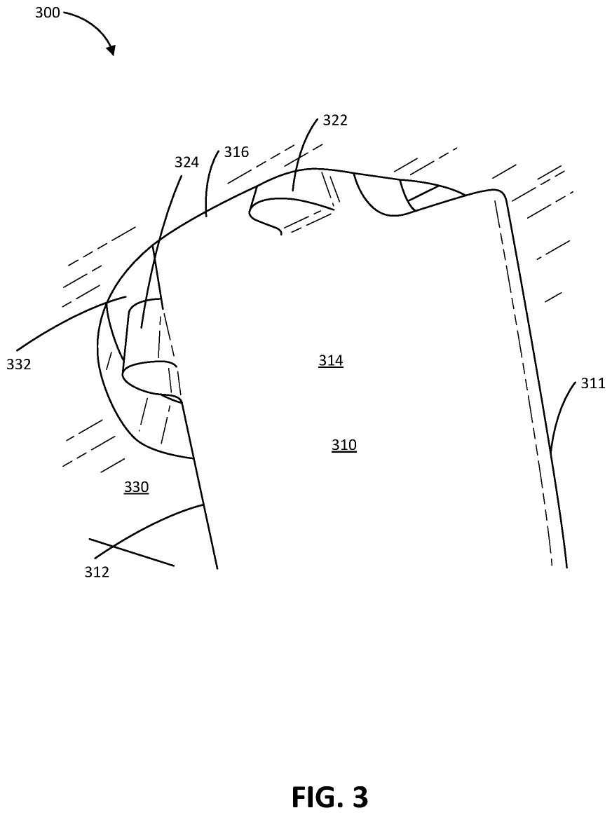

Referring now to FIG. 3, portion of a stator assembly prior to bonding of a potting component, in accordance with various embodiments, is illustrated. The stator assembly 300 comprises a vane 310 (e.g., exit guide vane 210 from FIG. 2), and an OD ring 330 (e.g., OD ring 218 from FIG. 2). Although depicted with respect to an OD ring 330, a vane 310 disposed in an ID ring in a similar manner is within the scope of this disclosure. In various embodiments, the OD ring 330 comprises a slot 332. The slot 332 may be configured to receive a portion of vane 310. In various embodiments, OD ring 330 comprises a recess configured to receive a portion of vane 310.

In various embodiments, the vane 310 comprises a leading edge 311, and a trailing edge 312. The vane 310 further comprises a suction side 314. In various embodiments, the suction side has a convex shape. The vane 310 further comprises a mating portion 316 extending into slot 332 of OD ring 330. In various embodiments, the mating portion 316 is a tip of a vane (e.g., when mating portion 316 is interfacing with an OD ring, such as OD ring 330) or a root (e.g., when mating portion 316 is interfacing with an ID ring, such as ID ring 217).

In various embodiments, vane 310 comprises a first bumper 322 disposed on the suction side 314 of vane 310. The first bumper 322 may be disposed proximate the leading edge 311 of vane 310. The first bumper 322 may have a radial height that is approximately equal to a thickness of OD ring 217. “Approximately equal,” as described herein, is +/−15%, or +/−10%, or +/−5%. The first bumper 322 may be radially aligned with slot 332. In various embodiments, first bumper 322 is integral to vane 310 (e.g., vane 310 and first bumper 322 are a part of a monolithic component). In various embodiments, a shim may be disposed between first bumper 322 and a surface defined by slot 332. The shim may provide a fixing point during assembly and the shim may be removed prior to bonding of a potting component 340.

In various embodiments, vane 310 may be made from any type of metal known in the art. For example, vane 310 may comprise an aluminum alloy, titanium alloy, or the like. Similarly, OD ring 330 may comprise any type of metal known in the art, such as an aluminum alloy, titanium alloy, or the like.

In various embodiments, vane 310 further comprises a second bumper 324 disposed on the suction side 314 of vane 310. The second bumper 324 may be disposed proximate the trailing edge 312 of vane 310. The second bumper 324 may have a radial height that is approximately equal to a thickness of OD ring 217. The second bumper 324 may be radially aligned with slot 332. In various embodiments, second bumper 324 is integral to vane 310 (e.g., vane 310 and second bumper 324 are a part of a monolithic component). In various embodiments, a shim may be disposed between second bumper 324 and a surface defined by slot 332. The shim may provide a fixing point during assembly and the shim may be removed prior to bonding of a potting component. The shim may allow fewer points to be fixed during assembly, allowing assembly to be less time consuming and more efficient.

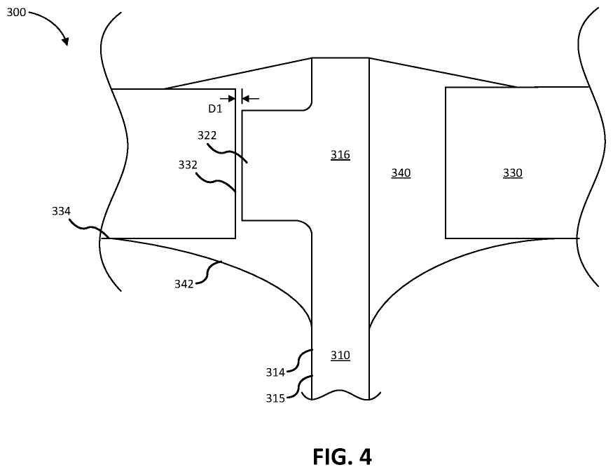

Referring now to FIG. 4, an axial cross-sectional view at a maximum thickness point of first bumper 322 from FIG. 3 of a portion of the stator assembly 300 after bonding of a potting component, in accordance with various embodiments, is illustrated. The stator assembly 300 comprises vane 310, OD ring 330, and potting component 340 coupling the vane 310 to the OD ring 330. In various embodiments, the vane 310 is coupled to the OD ring 330 by the potting component 340. For example, potting component 340 may be disposed in slot 332 of OD ring 330 and disposed between the and the mating portion 316 of vane 410 and slot 332. During assembly, the slot is completely filled with a potting component 340 in liquid form. Additionally, a portion of the potting component 340 may form a fillet 342 between a radially inner surface 334 of OD ring 330 and an airfoil surface 315 of vane 310. The fillet 342 may provide a more aerodynamic stator assembly 300 and/or provide greater strength properties of the joint. The potting component 340 may then be cured and join the mating portion 316 of vane 310 to OD ring 330. The potting component 430 may be a thermoplastic elastomer, silicone, silicone rubber, natural rubber, or the like. In various embodiments, the potting component 340 is made of silicone rubber. The potting component 340 may prevent direct contact between the OD ring 330 and the vane 310, which may prevent excitation of the vane 310 during operation of the gas turbine engine.

In various embodiments, first bumper 322 extends circumferentially outward from mating portion 316 of vane 310 toward a wall of slot 332. The first bumper 322 may be substantially orthogonal to suction side 314 of vane 310 at a local center point of first bumper 322. “Substantially orthogonal,” as defined herein is orthogonal +/−15%, or +/−10%, or +/−5%. In various embodiments, first bumper 322 may be separated from a wall of slot 332 by a distance D1. Distance D may be between 0.005 inches (0.012 cm) and 0.02 inches (0.05 cm), or between 0.006 inches (0.038 cm), or between 0.007 inches (0.018 cm) and 0.013 inches (0.033 cm). As such, the first bumper 322 may act as a deflection limiter during assembly. By having a first bumper as shown in FIG. 4, there is more support for a compressive load experienced on the potting component 340. As such, the potting component 340 may remain in tact during operation of the gas-turbine engine. The first bumper 322 and/or the second bumper 324 may prevent disbond of the potting component 340 during operation of the gas-turbine engine.

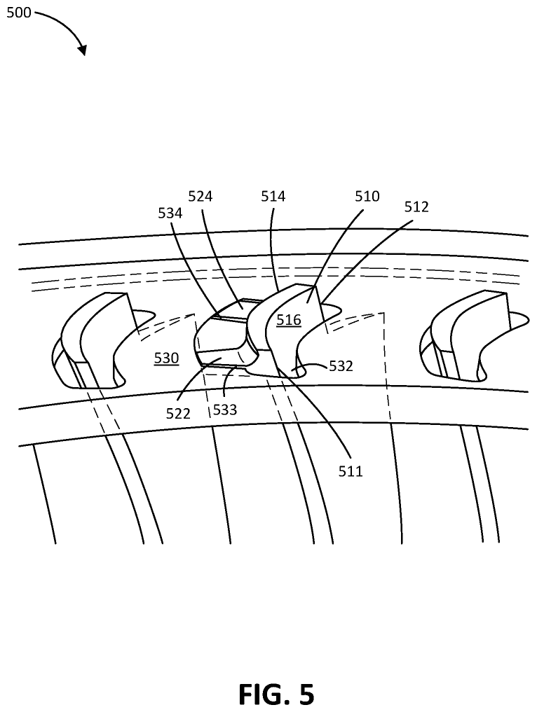

Referring now to FIG. 5, portion of a stator assembly prior to bonding of a potting component, in accordance with various embodiments, is illustrated. The stator assembly 500 comprises a vane 510 (e.g., exit guide vane 210 from FIG. 2), and an OD ring 530 (e.g., OD ring 218 from FIG. 2). Although depicted with respect to an OD ring 530, a vane 510 disposed in an ID ring in a similar manner is within the scope of this disclosure. In various embodiments, the OD ring 530 comprises a slot 532. The slot 532 may be configured to receive a portion of vane 510. In various embodiments, OD ring 530 comprises a recess configured to receive a portion of vane 510.

In various embodiments, the vane 510 comprises a leading edge 511 and a trailing edge 512. The vane 510 further comprises a suction side 514. In various embodiments, the suction side has a convex shape. The vane 510 further comprises a mating portion 516 extending into slot 532 of OD ring 530. In various embodiments, the mating portion 516 is a tip of a vane (e.g., when mating portion 516 is interfacing with an OD ring, such as OD ring 530) or a root (e.g., when mating portion 516 is interfacing with an ID ring, such as ID ring 217).

In various embodiments, vane 510 comprises a first tab 522 disposed on the suction side 514 of vane 510. The first tab 522 may be disposed proximate the leading edge 511 of vane 510. The first tab 522 may have a radial height that is approximately equal to a thickness of OD ring 217. “Approximately equal,” as described herein, is +/−15%, or +/−10%, or +/−5%. The first tab 522 may be radially aligned with slot 532. In various embodiments, first tab 522 is integral to vane 510 (e.g., vane 310 and first bumper 322 are a part of a monolithic component). In various embodiments, a shim may be disposed between first tab 522 and a surface defined by slot 532. The shim may provide a fixing point during assembly and the shim may be removed prior to bonding of a potting component.

In various embodiments, vane 510 may be made from any type of metal known in the art. For example, vane 510 may comprise an aluminum alloy, titanium alloy, or the like. Similarly, OD ring 530 may comprise any type of metal known in the art, such as an aluminum alloy, titanium alloy, or the like.

In various embodiments, vane 510 further comprises a second tab 524 disposed on the suction side 314 of vane 310. The second tab 524 may be disposed proximate the trailing edge 512 of vane 310. The second tab 524 may have a radial height that is approximately equal to a thickness of OD ring 217. The second tab 524 may be radially aligned with slot 532. In various embodiments, second tab 524 is integral to vane 510 (e.g., vane 350 and second tab 524 are a part of a monolithic component). In various embodiments, a shim may be disposed between second tab 524 and a surface defined by slot 532. The shim may provide a fixing point during assembly and the shim may be removed prior to bonding of a potting component. The shim may allow less points to be fixed during assembly, allowing assembly to be less time consuming and more efficient.

In various embodiments, slot 532 may comprise a first circumferential recess 533. The first circumferential recess 533 may be configured to receive first tab 522. In various embodiments, the first circumferential recess 533 may have a complimentary shape to first tab 522. In various embodiments, there may be a gap between a circumferential surface of first tab 522 and first circumferential recess.

In various embodiments, slot 532 may comprise a second circumferential recess 534. The second circumferential recess 534 may be configured to receive second tab 524. In various embodiments, the second circumferential recess 534 may have a complimentary shape to second tab 524. In various embodiments, there may be a gap between a circumferential surface of second tab 524 and second circumferential recess 534.

Referring now to FIG. 4, an axial cross-sectional view at of a portion of the stator assembly 500 after bonding of a potting component, in accordance with various embodiments, is illustrated. The stator assembly 500 comprises vane 510, OD ring 530, and potting component 540 coupling the vane 510 to the OD ring 530. In various embodiments, the vane 510 is coupled to the OD ring 530 by the potting component 540. For example, potting component 540 may be disposed in slot 532 of OD ring 530 and disposed between the and the mating portion 516 of vane 510 and slot 532. During assembly, the slot 532 is completely filled with a potting component 540 in liquid form. Additionally, a portion of the potting component 540 may form a fillet 542 between a radially inner surface 536 of OD ring 530 and an airfoil surface 515 of vane 510. The fillet 542 may provide a more aerodynamic stator assembly 500 and/or provide greater strength properties of the joint. The potting component 540 may then be cured and join the mating portion 516 of vane 510 to OD ring 530. The potting component 540 may be a thermoplastic elastomer, silicone, silicone rubber, natural rubber, or the like. In various embodiments, the potting component 540 is made of silicone rubber. The potting component 540 may prevent direct contact between the OD ring 530 and the vane 510, which may prevent excitation of the vane 510 during operation of the gas turbine engine.

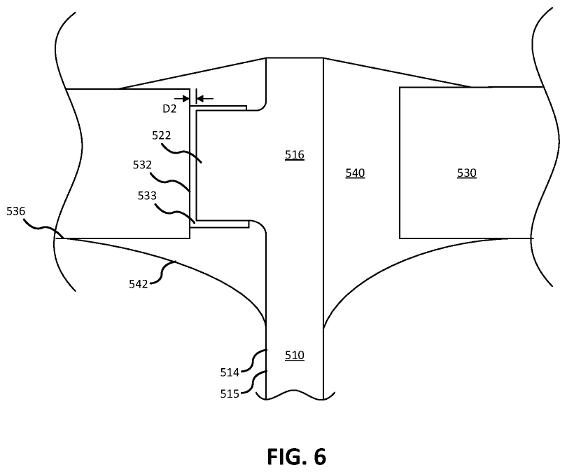

In various embodiments, first tab 522 extends circumferentially outward from mating portion 516 of vane 510 toward the first circumferential recess 533 of slot 532. The first tab 522 may be substantially orthogonal to suction side 514 of vane 510 at a local center point of first tab 522. “Substantially orthogonal,” as defined herein is orthogonal +/−15%, or +/−10%, or +/−5%. In various embodiments, first tab 522 may be separated from first circumferential recess 533 of slot 532 by a distance D2. Distance D2 may be between 0.005 inches (0.012 cm) and 0.02 inches (0.05 cm), or between 0.006 inches (0.038 cm), or between 0.007 inches (0.018 cm) and 0.013 inches (0.033 cm). As such, the first tab 522 may act as a deflection limiter during assembly. By having a first tab 522 as shown in FIG. 6, there is more support for a compressive load experienced on the potting component 540. As such, the potting component 540 may remain intact during operation of the gas-turbine engine.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A stator assembly, comprising:
a vane comprising a suction side, a mating portion, and a first bumper, the first bumper disposed on the suction side and extending circumferentially away from the suction side;
a ring having a slot configured to receive the vane;
a potting component disposed between the mating portion of the vane and the slot of the ring, the potting component configured to join the vane and the ring.

2. The stator assembly of claim 1, wherein the first bumper extends substantially orthogonal to the suction side.

3. The stator assembly of claim 1, wherein the first bumper is disposed proximate a leading edge of the vane.

4. The stator assembly of claim 3, further comprising a second bumper disposed on the suction side of the vane.

5. The stator assembly of claim 4, wherein the second bumper is disposed proximate a trailing edge of the vane.

6. The stator assembly of claim 1, wherein the vane is a monolithic component.

7. A stator assembly, comprising:
a vane comprising a suction side, a mating portion, and a first tab, the first tab disposed on the suction side and extending circumferentially away from the suction side;
a ring having a slot configured to receive the vane;
a potting component disposed between the mating portion of the vane and the slot of the ring, the potting component configured to join the vane and the ring.

8. The stator assembly of claim 7, wherein the first tab extends substantially orthogonal to the suction side.

9. The stator assembly of claim 8, further comprising a first circumferential recess disposed in the slot proximate the first tab, wherein the first circumferential recess is configured to receive the first tab.

10. The stator assembly of claim 7, wherein the first tab is disposed proximate a leading edge of the vane.

11. The stator assembly of claim 10, further comprising a second tab disposed on the suction side of the vane.

12. The stator assembly of claim 11, wherein the second tab is disposed proximate a trailing edge of the vane.

13. The stator assembly of claim 12, further comprising a second circumferential recess disposed in the slot proximate the second tab, wherein the second circumferential recess is configured to receive the second tab.

14. The stator assembly of claim 7, wherein the vane is a monolithic component.

15. A gas-turbine engine, comprising:
a compressor section;
a stator assembly disposed aft of the compressor section, the stator assembly comprising:
a vane comprising a suction side, a mating portion, and a first tab or a first bumper, the first tab or the first bumper disposed on the suction side and extending circumferentially away from the suction side;
a ring having a slot configured to receive the vane; and
a potting component disposed between the mating portion of the vane and the slot of the ring, the potting component configured to join the vane and the ring.

16. The gas-turbine engine of claim 15, wherein the ring further comprises a first circumferential recess disposed in the slot proximate the first tab, wherein the first tab or the first bumper is the first tab.

17. The gas-turbine engine of claim 16, wherein the first tab is disposed proximate a leading edge of the vane, wherein the vane further comprises a second tab disposed on the suction side proximate a trailing edge of the vane, the second tab extending circumferentially away from the suction side.

18. The gas-turbine engine of claim 17, wherein the ring further comprises a second circumferential recess disposed in the slot proximate the second tab, wherein the second circumferential recess is configured to receive the second tab.

19. The gas-turbine engine of claim 15, wherein the first bumper or the first tab is the first bumper.

20. The gas-turbine engine of claim 15, wherein the vane is a monolithic component.
